(19) United States
(12) Patent Application Publication
(10) Pub. No.: US 2016/0346729 A1
(43) Pub. Date: Dec. 1, 2016

(54) FACILITY FOR PURIFYING HARMFUL GAS

(71) Applicant: Core Plasma Technology Inc., Williamsburg, VA (US)

(72) Inventors: Won Ju YI, Williamsburg, VA (US); David Young Eun Yi, Beaverton, OR (US); Daniel Young Hyun Yi, Beaverton, OR (US)

(73) Assignee: Core Plasma Technology Inc., williamsburg, VA (US)

(21) Appl. No.: 15/081,956

(22) Filed: Mar. 28, 2016

(30) Foreign Application Priority Data
May 27, 2015 (KR) 10-2015-0073860
May 27, 2015 (KR) 10-2015-0073861
Nov. 24, 2015 (KR) 10-2015-0164768

(51) Int. Cl. B01D 53/32; B01D 53/00

(52) U.S. Cl. CPC B01D 53/32; B01D 53/007; B01D 2259/818; B01D 2259/806

(57) ABSTRACT

A facility for purifying harmful gas disposing harmful gas discharged from at least one process chamber in which processes are performed in the vacuum status by a vacuum pump, the facility including: one or a plurality of microwave generators generating microwave; a plurality of wave guides including a wave path through which the microwave generated by the microwave generator is provided; a plasma discharge chamber including the wave guides connected by a certain distance along the harmful gas flow direction outside; and a shield installed inside the plasma discharge chamber preventing ions or electrons for the plasma discharge from leaking outside by contacting with the plasma discharge chamber.

### CROSS-REFERENCE TO RELATED APPLICATIONS

This application claims priority under 35 U.S.C. §119 to Korean Patent Application Nos. 10-2015-0073860, filed on May 27, 2015, 10-2015-0073861, filed on May 27, 2015, and 10-2015-0164768 filed on Nov. 24, 2015 in the Korean Intellectual Property Office, the entire contents of which are incorporated herein by reference.

### BACKGROUND

The present invention relates to a facility for purifying harmful gas, and more particularly, to a facility for purifying harmful gas having high remove efficiency of noxious substances in harmful gas discharged by a process chamber and reducing expense.

Various raw materials are injected into a process chamber of low pressure, and processes such as ashing, evaporation, etching, photolithographic process, cleaning, nitration, and so on, are performed in the process of manufacturing semiconductors or displays. Harmful gas including noxious substances which are the restriction for the use of certain hazardous substances for environment including various volatile organic compounds, acids, odor generating gas, ignition material and non-CO₂ greenhouse gas is generated during the processes. Thus, the process chamber is required to be vacuum status to remove the harmful gas by a vacuum pump and to discharge the harmful gas into the air after purifying process.

FIG. 1 shows a conventional facility for disposing harmful gas, which includes a process chamber 10, a plasma reactor 30 below the process chamber 10 for removing noxious substances in harmful gas, and a vacuum pump 50 below the plasma reactor 30. The process chamber 10 and the plasma reactor 30 are connected by a pipe 20, so are the plasma reactor 30 and the vacuum pump 50.

The conventional plasma reactor 30 installed in such the facility for disposing harmful gas applies methods of radio frequency and inductively coupled plasma which may have low discharging stability, thereby requiring additional apparatuses for stabilizing discharging. The Korean patent registrations No. 10-1278682 and No. 10-1063515 disclosed a new plasma reactor to overcome the above problem of the conventional plasma reactor. The developed plasma reactor applies a method of Alternating Current (AC) discharge, thus, the use of electricity may be large, and the intensity of plasma in the center part of a conduit may be decreased even though large amount of harmful gas flows, which results in decline of decomposition performance of harmful gas. Furthermore, expense for installing two plasma reactor to reinforce decomposition performance of harmful gas with one plasma reactor may be doubled, which results in great increase of initial cost.

### DETAILED DESCRIPTION OF THE INVENTION

### Technical Problem of the Invention

The present invention provides a facility for purifying harmful gas for removing noxious substances or particles in the harmful gas generated during the semiconductor process, display process, etc.

### Technical Solution of the Invention

A facility for purifying harmful gas disposing harmful gas discharged from one or a plurality of process chambers in a vacuum status by a vacuum pump according to an exemplary embodiment of inventive concept includes one or a plurality of microwave generators generating microwave, a plurality of wave guides including a wave path through which the microwave generated by the microwave generator is provided, a plasma discharge chamber installed to be separated with each other by a certain distance along the harmful gas flow direction, wherein when the harmful gas is input through the wave guide, the microwave is reflected inside the plasma discharge chamber to form a plurality of plasma discharge regions in which plasma discharge is generated, and a shield installed inside the plasma discharge chamber to be longer than the length between plasma discharge regions for covering the plasma discharge regions at the same time, being formed with a tube cylinder for flowing the harmful gas input from the process chamber or a part of it, and preventing ions or electrons to be used for the plasma discharge from leaking outside by contacting with the plasma discharge chamber.

A facility for purifying harmful gas disposing harmful gas discharged from one or a plurality of process chambers in a vacuum status by a vacuum pump according to another exemplary embodiment of inventive concept includes a microwave generator generating microwave, a first microwave splitting unit separating the microwave generated by the microwave generator, a second microwave splitting unit separating the first microwave separated by the first microwave splitting unit, a plurality of wave guides including a wave path through which the second microwave separated by the second microwave splitting unit, a plasma discharge chamber including the wave guides installed to be separated with each other by a certain distance along the harmful gas flow direction outside, wherein when the second microwave is input through the wave guide, the second microwave is reflected inside the plasma discharge chamber to form a plurality of plasma discharge regions in which plasma discharge is generated by the second microwave, and a shield installed inside the plasma discharge chamber to be longer than the length between plasma discharge regions for covering the plasma discharge regions at the same time, being formed with a tube cylinder for flowing the harmful gas input from the process chamber or a part of it, and preventing ions or electrons to be used for the plasma discharge from leaking outside by contacting with the plasma discharge chamber. And the facility for purifying harmful gas further includes a plurality of vacuum pumps so as to discharge harmful gas in one of the process chambers. The second microwave splitting unit transfers the second microwave to the wave guides connected to the front of the vacuum pumps, respectively, in the plasma discharge chamber.

A facility for purifying harmful gas disposing harmful gas discharged from one or a plurality of process chambers in a vacuum status by a vacuum pump according to yet another exemplary embodiment of inventive concept includes a microwave generator generating microwave, a first microwave splitting unit separating the microwave generated by the microwave generator, a second microwave splitting unit separating the first microwave separated by the first microwave splitting unit, a plurality of wave guides including a wave path through which the second microwave separated by the second microwave splitting unit, a plasma discharge chamber including the wave guides installed to be separated with each other by a certain distance along the harmful gas flow direction outside, wherein when the second microwave is input through the wave guide, the second microwave is reflected inside the plasma discharge chamber to form a plurality of plasma discharge regions in which plasma discharge is generated by the second microwave, and a shield installed inside the plasma discharge chamber to be longer than the length between plasma discharge regions for covering the plasma discharge regions at the same time, being formed with a tube cylinder for flowing the harmful gas input from the process chamber or a part of it, and preventing ions or electrons to be used for the plasma discharge from leaking outside by contacting with the plasma discharge chamber. And the facility for purifying harmful gas further includes a plurality of vacuum pumps so as to discharge harmful gas in one of the process chambers. The second microwave splitting unit transfers the second microwave to the wave guides connected to the rear side of the vacuum pumps, respectively, in the plasma discharge chamber.

### Effects of the Invention

A facility for purifying harmful gas according to embodiments of the present invention includes a plurality of wave guides connected to one plasma discharge chamber to form a plurality of plasma discharge regions performing plasma discharge, which makes it possible harmful gas to be exposed to the plasma discharge by the plural times while flowing in the plasma discharge chamber, thereby more noxious substances in the harmful gas being decomposed.

Plasma discharge is started by constructive interference along the harmful gas flow direction (firing discharge), and then, the plasma discharge is diffused by plasma particles by firing discharge, accordingly, the decomposition performance for noxious substances in the harmful gas may be much more improved.

A length of a shield covering plasma discharge regions is longer than the distance between the plasma discharge regions in the plasma discharge chamber, accordingly, ions or electrons in the plasma discharge regions to be used for the plasma discharge may not leak to the outside by preventing from contacting with the plasma discharge chamber, resulting in efficiency increase.

One shield is used for covering the plurality of discharge regions, thereby the structure being compact and time and expense for manufacturing being reduced.

### BRIEF DESCRIPTION OF THE DRAWINGS

Exemplary embodiments of the inventive concept will be more clearly understood from the following detailed description taken in conjunction with the accompanying drawings in which:

FIG. 1 is a schematic view of a conventional facility for purifying harmful gas;

FIG. 2 is a schematic view of a facility for purifying harmful gas according to an exemplary embodiment of the present inventive concept;

FIG. 3 is a cross-sectional view of a cross-section area along the line of A-A′ of FIG. 2;

FIG. 4 is a cross-sectional view of a cross-section area along the line of B-B′ of FIG. 2;

FIG. 5 is a modified exemplary embodiment of a facility for purifying harmful gas according to the exemplary embodiment of the present inventive concept;

FIG. 6 is a schematic view of a facility for purifying harmful gas according to another exemplary embodiment of the present inventive concept;

FIG. 7 is a schematic view of a facility for purifying harmful gas according to yet another exemplary embodiment of the present inventive concept;

FIG. 8 is a schematic view of a facility for purifying harmful gas according to still yet another exemplary embodiment of the present inventive concept;

FIG. 9 is a schematic view of a facility for purifying harmful gas according to still yet another exemplary embodiment of the present inventive concept;

FIG. 10 is a schematic view of a facility for purifying harmful gas according to still yet another exemplary embodiment of the present inventive concept; and

FIG. 11 is a schematic view of a facility for purifying harmful gas according to still yet another exemplary embodiment of the present inventive concept.

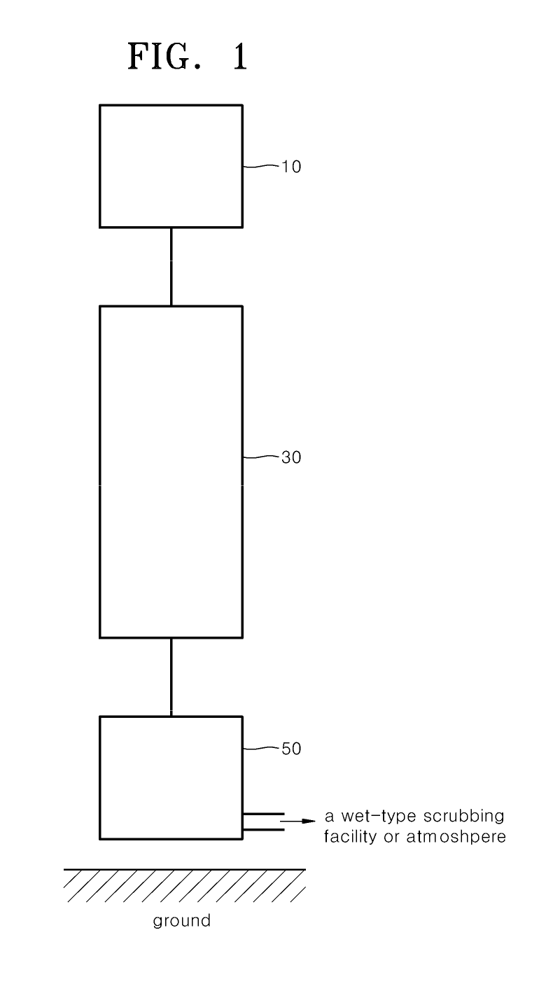

### BEST MODE FOR CARRYING OUT THE INVENTION

Various example embodiments will be described more fully hereinafter with reference to the accompanying drawings, in which some example embodiments are shown. Inventive concepts may, however, be embodied in many different forms and should not be construed as limited to the example embodiments set forth herein. Rather, example embodiments are provided so that this disclosure will be thorough and complete, and will fully convey the scope of inventive concepts to those skilled in the art. In the drawings, the sizes and relative sizes of layers and areas may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the inventive concepts. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacently” versus “directly adjacently,” etc.).

The terminology used herein is for the purpose of describing particular example embodiments only and is not intended to be limiting of the inventive concepts. As used herein, the singular forms “a,” “an” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

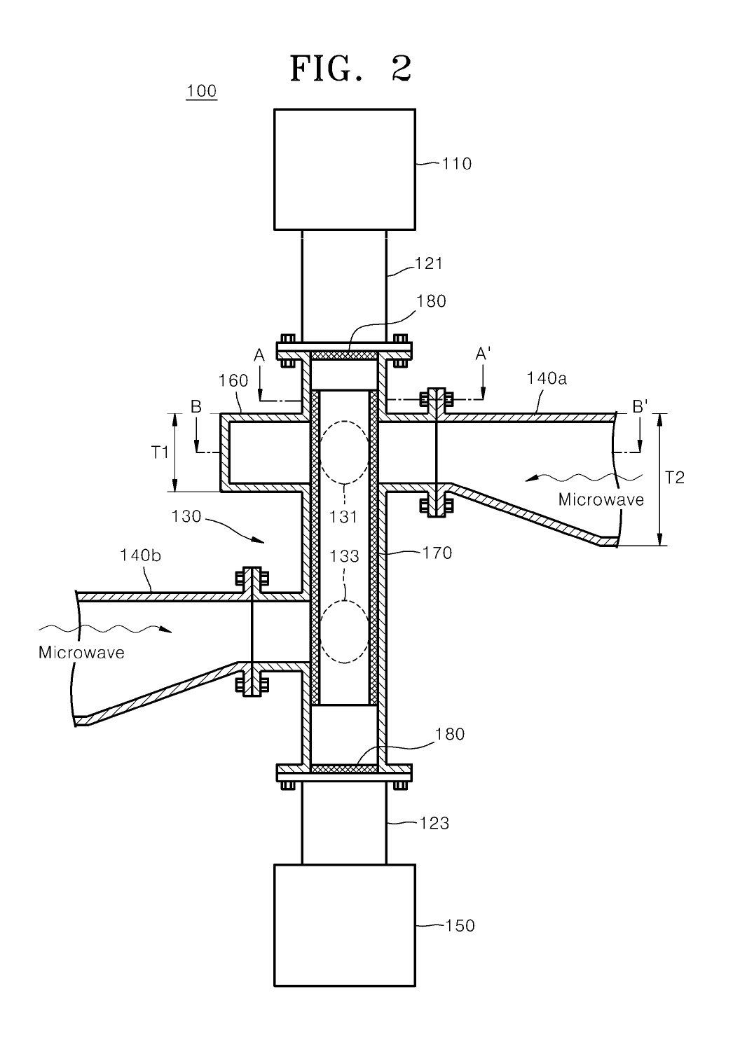

FIGS. 2 through 9 show a facility for purifying harmful gas according to exemplary embodiments of the inventive concept. Prior to the explanation, the facility for purifying harmful gas according to exemplary embodiments of the inventive concept is for discharging harmful gas generated by a process chamber performing processes in a vacuum status by a vacuum pump.

Referring to FIG. 2, the facility for purifying harmful gas 100 according to an exemplary embodiment of the inventive concept includes a process chamber 110, a microwave generator (not shown), wave guides 140a, 140b, a plasma discharge chamber 130, a shield 170, and a vacuum pump 150.

The process chamber 110 is a chamber in which various operations of semiconductor or display process such as ashing, evaporation, etching, photolithography, cleaning, nitration, and so on, are performed. The exemplary embodiment takes the example of etching for the process in the process chamber 110. Various kinds of process gas and buffer gas are provided during the etching process, and the process gas used for the etching process are noxious substances such as CF₄ and NF₃. A part of the harmful process gas may not be used and may be discharged from the process chamber 110.

The vacuum pump 150 makes the insides of the process chamber 110 and the plasma discharge chamber 130 to be vacuum state that has lower pressure than the air pressure and performs discharging remaining harmful gas from the process chamber 110 after the etching process. The vacuum pump 150 also makes the vacuum environment between the process chamber 110 and the vacuum pump 150.

Meanwhile, the vacuum pump 150 includes an exhaust pipe (not shown) at the latter end such that the harmful gas may be discharged to the air through the exhaust pipe. Or the scrubber (not shown) may be further installed at the latter end of the vacuum pump 150. For example, the scrubber (not shown) may be a wet scrubbing apparatus.

The harmful gas generated during the etching process in the process chamber 110 includes unreacted material and by-products during the process as noxious substances. Thus, the plasma discharge chamber 130 and the wave guides 140a, 140b are installed between the process chamber 110 and the vacuum pump 150 to remove the noxious substances in the harmful gas, and plasma generated by microwave input through the wave guides 140a, 140b in the plasma discharge chamber 130 boosts decomposing noxious substances in the harmful gas so as the noxious substances to be removed. Descriptions with regards to this will be explained later in detail.

At least one of the microwave generator (not shown) is prepared and generates microwave. In the present exemplary embodiment, a plurality of the microwave generators (not shown) are prepared to correspond to the wave guides 140a, 140b. The microwave generated by the microwave generator (not shown) is provided to the plasma discharge chamber 130 so as to generate plasma discharge. A magnetron is applied to manufacture the microwave generator (not shown), but the embodiment is not restricted thereto.

The microwave generated by the microwave generator (not shown) is provided to the plasma discharge chamber 130, as described above, and more specifically, is provided through the wave guides 140a, 140b to the plasma discharge chamber 130. That is, the microwave generated by each microwave generator (not shown) is provided to the plasma discharge chamber 130 through each of the wave guides 140a, 140b.

The wave guides 140a, 140b include wave paths formed to transfer the microwave provided by the microwave generator (not shown). That is, the microwave flows along the wave paths in the wave guides 140a, 140b.

The wave guides 140a, 140b are installed so as to be connected to the plasma discharge chamber 130 separated with each other by a predetermined distance along the flow direction of the harmful gas as shown in FIG. 2. The microwave is provided to the plasma discharge chamber 130 through the wave guides 140a, 140b and generates plasma discharge so as to decompose noxious substances in the harmful gas. The wave guides are prepared by two, 140a, 140b.

The present embodiment shows that the wave guides 140a, 140b are installed in a symmetric structure based on the plasma discharge chamber 130, but embodiments are not restricted thereto, and the wave guides 140a, 140b may be installed in parallel with respect to the plasma discharge chamber 130 or at various angles like 90° based on the axis of the plasma discharge chamber 130.

Although it will be described later, two plasma discharge regions in which plasma discharge is generated are formed in the plasma discharge chamber 130. Accordingly, two wave guides 140a, 140b are connected to the plasma discharge chamber 130 so as to correspond to each of the plasma discharge regions.

The plasma discharge chamber 130 is arranged between a first pipe 121 in which the harmful gas discharged from the process chamber 110 flows and a second pipe 123 in which the harmful gas flows to the vacuum pump 150 so as to be detachable with regards to the first pipe 121 and the second pipe 120. But the embodiment is not districted thereto, and the plasma discharge chamber 130 may be installed at the rear side of the vacuum pump 150 or between the vacuum pumps in case of preparing a plurality of vacuum pumps.

The plasma discharge chamber 130 includes an interior space of a through hole formed along the longitudinal direction. The microwave is provided to the interior space through the wave guides 140a, 140b, as described above. The harmful gas discharged from the process chamber 110 is input to the interior space of the plasma discharge chamber 130 and noxious substances therein contact with the microwave to generate plasma discharge. Accordingly, the plasma discharge chamber 130 includes an inlet through which the harmful gas discharged from the process chamber 110 is input and an outlet through which the harmful gas is discharged to the vacuum pump 150.

The interior side of the plasma discharge chamber 130 is formed to reflect the microwave provided through the wave guides 140a, 140b. A reflection chamber 160, will be described later, is formed in the region where firing discharge is generated of the plasma discharge chamber 130, which is also formed to reflect the microwave. Meanwhile, the reflection chamber 160 may be installed separately so as to surround the plasma discharge chamber 130, and at this time, the rest region except for the region corresponding to the region surrounded by the reflection chamber 160 in the interior of the plasma discharge chamber 130 may reflect the microwave. That is, the region surrounded by the reflection chamber 160 in the plasma discharge chamber 130 may transmit the microwave.

The region transmitting the microwave in the plasma discharge chamber 130 is formed of a material transmitting the microwave such as quartz, ceramic, plastic, and carbon.

Both of the plasma discharge chamber 130 and the reflection chamber 160 reflect the microwave, accordingly, being formed of a conductive material.

The plasma discharge chamber 130 may be various forms of a rectangular parallelepiped, a cylinder, and so on. The plasma discharge chamber 130 in the present embodiment is a cylinder form. The plasma discharge chamber 130 includes a plurality of plasma discharge regions in which plasma discharge are generated by the microwave generated by the microwave generator (not shown) and formed along the flow direction of the harmful gas.

A first region 131 (hereinafter, referred to as a firing discharge region) and a second region 133 (hereinafter, referred to as a diffusing discharge region) are formed. The first region 131 is formed by constructive interference in the plasma discharge region. The second region 133 is formed by assistance of plasma particles transferred from the first region. The first region 131 is formed before the second region 133, but the embodiment is not restricted thereto. The plasma discharge chamber 130 includes the first region 131 and the second region 133, accordingly, two wave guides 140a, 140b are connected to the plasma discharge chamber 130.

One plasma discharge chamber 130 includes the first region 131 and the second region 133, but embodiments are not restricted thereto, the plasma discharge chamber may be prepared by the plural, such that each of the plasma discharge chamber may generate plasma discharge. Like the above, for the plural plasma discharge chamber, a connecting member (not shown) may be required to connect the next plasma discharge chamber.

Although not shown in drawings, the plasma discharge chamber 130 includes a reaction gas provider (not shown). The reaction gas provider (not shown) is installed adjacent to the inlet of the plasma discharge chamber 130 and provides reaction gas into the plasma discharge chamber 130 when the harmful gas is input thereto.

The reaction gas is one of H₂O, gas (O₂, O₃, or, H₂), or liquid. Decomposition of noxious substances in the harmful gas only with the microwave may not be successful, because kinds of the noxious substances are various. Accordingly, the reaction gas to be input to the inside of the plasma discharge chamber 130 may be mixed with the harmful gas to generate plasma discharge with the microwave more actively by boosting the formation of O/O₂ radical and OH radical.

Also, the reaction gas makes the harmful gas flow like a swirl when they are mixed together inside the plasma discharge chamber 130, as a result, the harmful gas may stay inside the plasma discharge chamber 130 longer so that time for generating plasma discharge with the microwave may be increased. This improves the decomposition performance of noxious substances in the harmful gas.

The shield 170 is arranged inside the plasma discharge chamber 130 to prevent ions and electrons for the plasma discharge from leaking out of the plasma discharge chamber 130 when contact with the plasma discharge chamber 130. The shield 170 is required to transmit the microwave, so it is formed of quartz or ceramic conduit. Accordingly, ions and electrons generated in the plasma discharge may not leak to the outside by contacting with the plasma discharge chamber.

The shield 170 is a cylinder form with a through hole, that is, a cylinder tube, and is formed to be longer than the distance from the first region 131 and the second region 133. In other words, the one shield 170 covers the first region 131 and the second region 133 at the same time and prevents ions and electrons for the plasma discharge from leaking out of the plasma discharge chamber 130 by contacting with the plasma discharge chamber 130.

A plurality of shields 170 may be installed so as to cover the first region 131 and the second region 133, respectively, by corresponding to each of the regions, but the shields 170 are configured to be inserted into the plasma discharge chamber 170, thereby not being easy to define their positions to correspond to each region. In addition, installing plural shields may be complicated in the structure and may increase the expense, because each of the shields may require vacuum sealing.

The long shield 170 of the present embodiment makes it easier to be inserted to the inside of the plasma discharge chamber 130 and performs shielding of ions and electrons in the first region 131, the second region 133 and even in the space between the two regions from leaking out of the plasma discharge chamber 130 by contacting with the plasma discharge chamber 130.

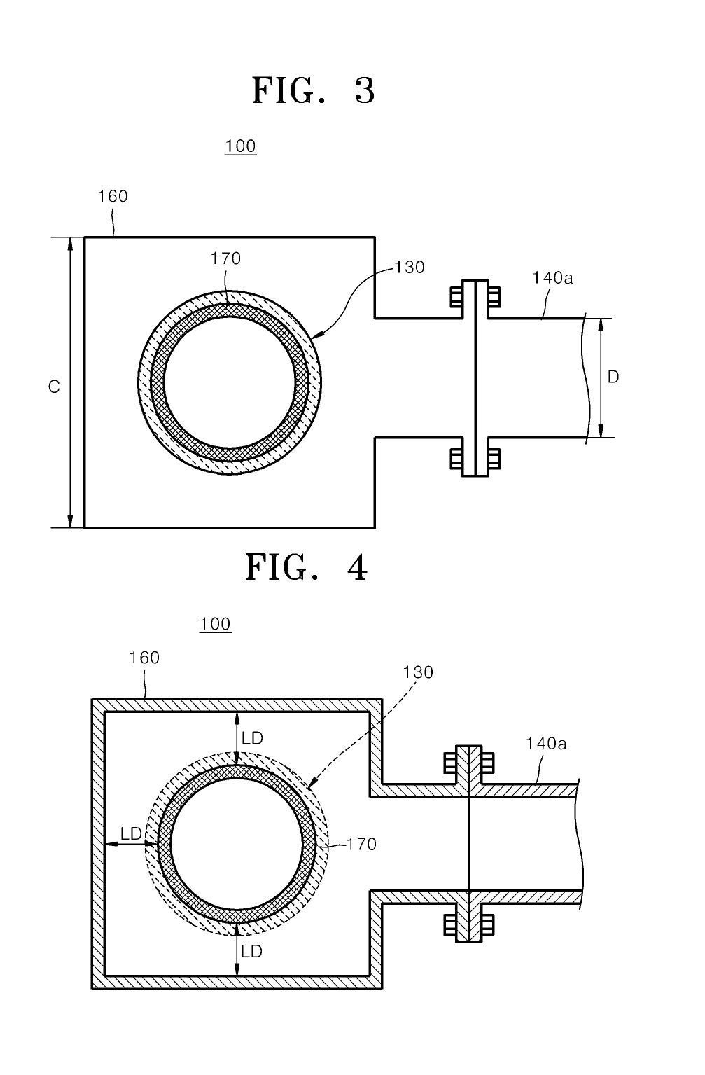

The shield 170 is inserted to the plasma discharge chamber 130 so as to be attached to the inner surface of the plasma discharge chamber 130 as shown in FIGS. 3 and 4. But the shield 170 may be separated from the inner surface of the plasma discharge chamber 130 by an O-ring structure or by a sensor sensing cracks in the shield 170. The shield 170 is separated from the inner surface of the reflection chamber 160 such that various sensors such as a temperature sensor monitoring the condition inside of the shield 170 or refrigerant such as cooling fluid and thermal transfer (not shown) for cooling the shield 170 may be inserted to the space between the shield 170 and the inner surface of the reflection chamber 160.

A setting distance (LD) between the shield 170 and the inner surface of the reflection chamber 160 is defined by the following [Equation 1]. But the decomposition performance of the noxious substances may not be affected by the shield position, because constructive interference may be generated regardless whether the shield 170 is separated from the reflection chamber 160. ±⅛×λ of the Equation 1 denotes error range.

LD=(2n+1)/4×λ±⅛×λ [Equation 1]

where LD is the setting distance, λ is a wavelength of the microwave, and n is 0 or positive integer.

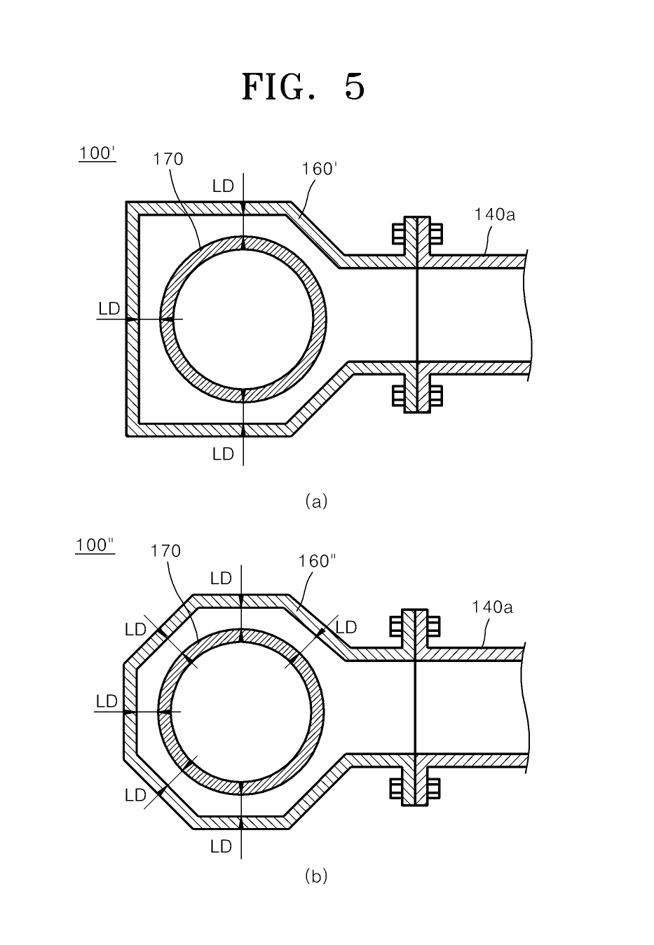

FIG. 5 shows various examples of the LD according to the shape of the reflection chamber in the facility for purifying harmful gas 100′, 100″. The microwave input from the wave guide 140a generates plasma discharge in the plasma discharge chamber 130, especially, firing discharge during the repeated reflection by the reflection chamber 160′, 160″, while ions or electrons being prevented from leaking out by the shield 170.

Meanwhile, the facility for purifying harmful gas 100 further includes the reflection chamber 160 and a mesh member 180. The reflection chamber 160 generates constructive interference in the microwave input to the plasma discharge chamber 130. That is, the reflection chamber 160 is formed in the area where firing discharge is generated. The reflection chamber 160 is extended from the plasma discharge chamber 130, wherein the size of the cross-section of the reflection chamber 160 is larger than the one of the plasma reflection chamber 130. The reflection chamber 160 is positioned to correspond to the position of the wave guide 140a.

The reflection chamber 160 is installed at the position corresponding to the wave guide 140a connected to the first region 131 near the inlet of the discharge chamber 130.

The microwave generated from the microwave generator (not shown) is input to the plasma discharge chamber 130 through the wave guide 140a and then to the reflection chamber 160 to be reflected by the reflection chamber 160. The reflected microwave generates constructive interference with the microwave input to the reflection chamber 160 from the microwave generator (not shown). During the constructive interference in the reflection chamber 160, electric fields converge to generate firing discharge.

Meanwhile, the first region 131 and the second region 133 are formed in the plasma discharge chamber 130. The first region 131 which is formed earlier along the harmful gas flow direction performs plasma discharge (Firing discharge) with constructive interference by the reflection chamber 160.

On the other hand, the reflection chamber 160 may not be formed in the second region 133 separated from the first region 131 by a predetermined distance. The second region 133 generates diffusing discharge when the microwave floating to the second region 133 and plasma particles generated by the plasma discharge in the first region 131 floating to the second region 133 collide each other (Diffusing discharge).

The diffusing discharge is generated with assistance from plasma discharge particles generated by the firing discharge of the first region 131, accordingly, the electric field force of the second region 133 may be weaker than the one of the first region 131 in which firing discharge is generated. Also, the plasma output to be transferred to the first region 131 in which firing discharge is generated may be larger than the plasma output to be transferred to the second region 133 in which diffusing discharge is generated.

Meanwhile, the cross-section area of the plasma discharge chamber 130 becomes larger when the amount of the harmful gas flow into the plasma discharge chamber 130 increases. Accordingly, the width of the reflection chamber 160 becomes necessarily large, but total energy by the microwave input through the wave guide 140a may not be changed practically. Thus, the electric field force inside the plasma discharge chamber 130 may be weakened due to the increased width C of the reflection chamber 160.

The plasma discharge generated in the first region 131 may not be stable due to the reduced electric field force like the above. To overcome the above, the average thickness T1 of the reflection chamber 160 is set to be thinner than the average thickness T2 of the wave guide 140a, and the average width C of the reflection chamber 160 larger than the average width D of the wave guide 140a.

The mesh member 180 is installed inside the plasma discharge chamber 130, and more particularly, at the inlet and outlet of the plasma discharge chamber 130, respectively.

The mesh member 180 passes the harmful gas or gas including decomposed noxious substances in the harmful gas, but not the microwave. The mesh member 180 includes a plurality of holes (not shown) to pass the harmful gas or gas including decomposed noxious substances in the harmful gas, but the microwave may not pass through the holes and be reflected.

The microwave may not pass through the hole with the size of smaller than a fourth of the microwave wavelength. Thus, the size of each hole in the mesh is configured to be smaller than a fourth of the microwave wavelength such that the microwave may not pass through the mesh 180 and be reflected continuously inside the plasma discharge chamber 130.

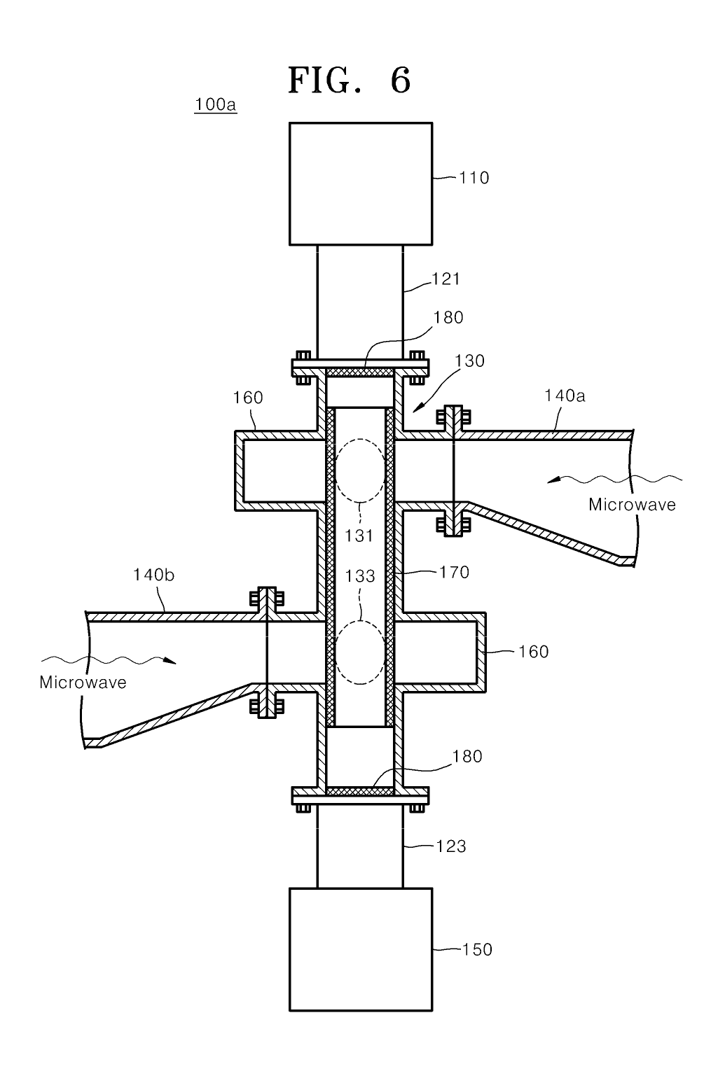

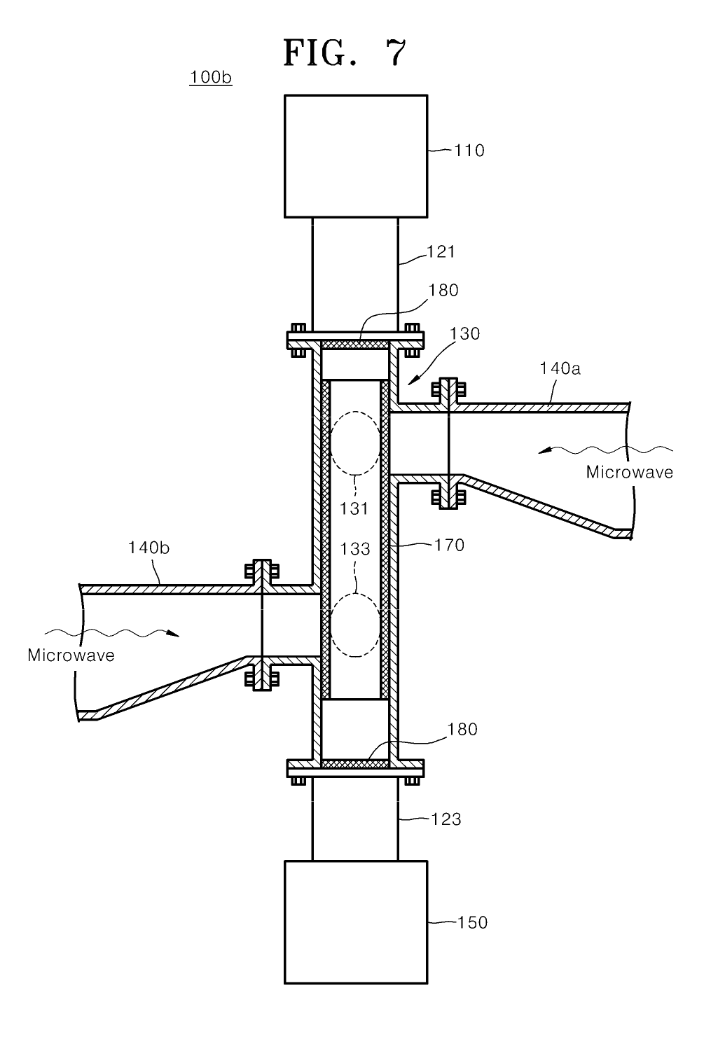

FIGS. 6 and 7 show facilities for purifying harmful gas 100a, 100b according to another exemplary embodiment of the present inventive concept. Most of the structures are identical to those in the facility for purifying harmful gas 100 of FIG. 2, but a part of the structures is different. Identical structures have identical drawing references, and only the differences will be described hereinafter.

The facility for purifying harmful gas 100a of FIG. 6 includes a plurality of the reflection chambers 160. The reflection chamber 160 is installed to be extended from the plasma reflection chamber 130 at the position of the first region 131 where the wave guide 140a is connected, and the other reflection chamber 160 is installed to be extended from the plasma reflection chamber 130 at the position of the second region 132 where the wave guide 140b is connected.

The first region 131 and the second region 133 may perform firing discharge due to constructive interference in the plurality of reflection chambers 160, thereby the decomposition performance of noxious substances in the harmful gas in this state being much more improved.

On the contrary, the facility for purifying harmful gas 100b of FIG. 7 includes no reflection chamber 160. The facility for purifying harmful gas 100b may be weak in plasma discharge generation compared to the facilities for purifying harmful gas 100, 100a in FIG. 2 and FIG. 6, but the facility 100b which is comparatively compact in FIG. 7 is enough to dispose noxious substances in harmful gas in case of small amount of harmful gas flow from the process chamber 110. In addition, the compact structure may contribute to cost reduction.

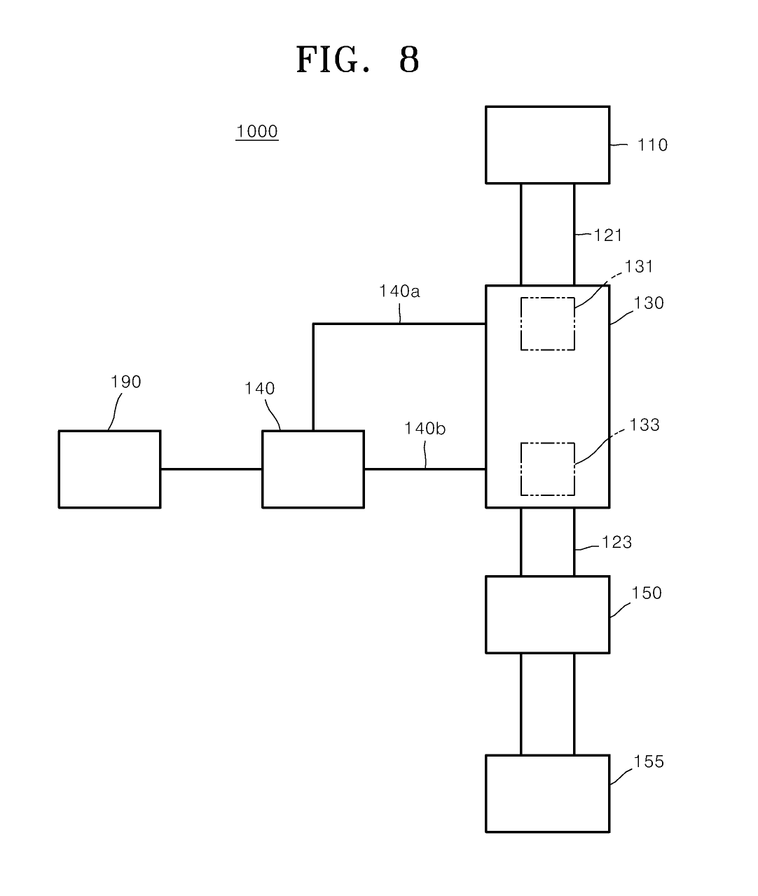

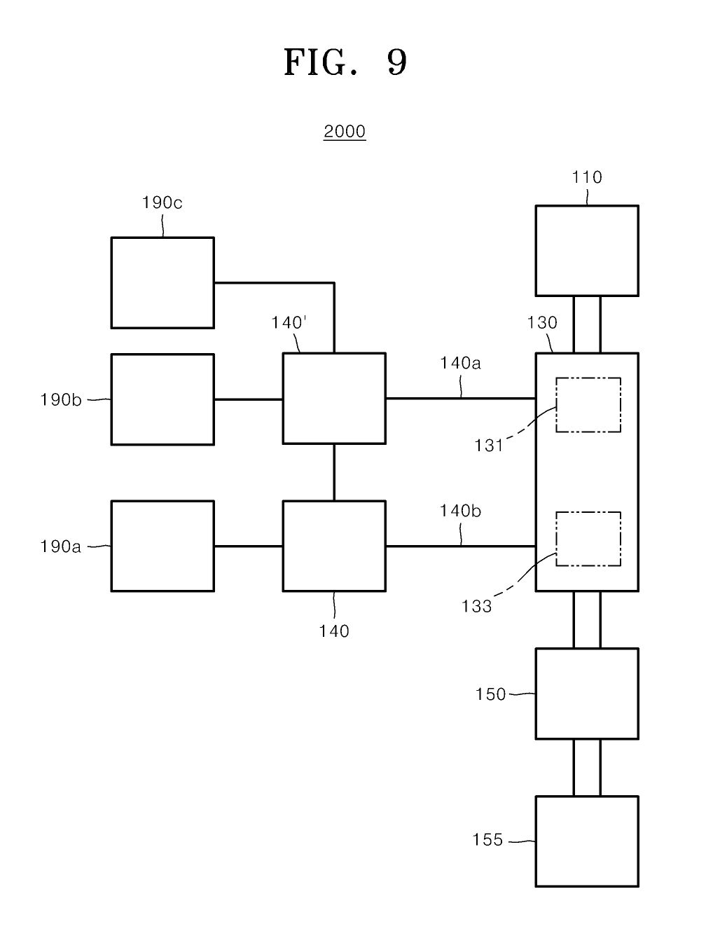

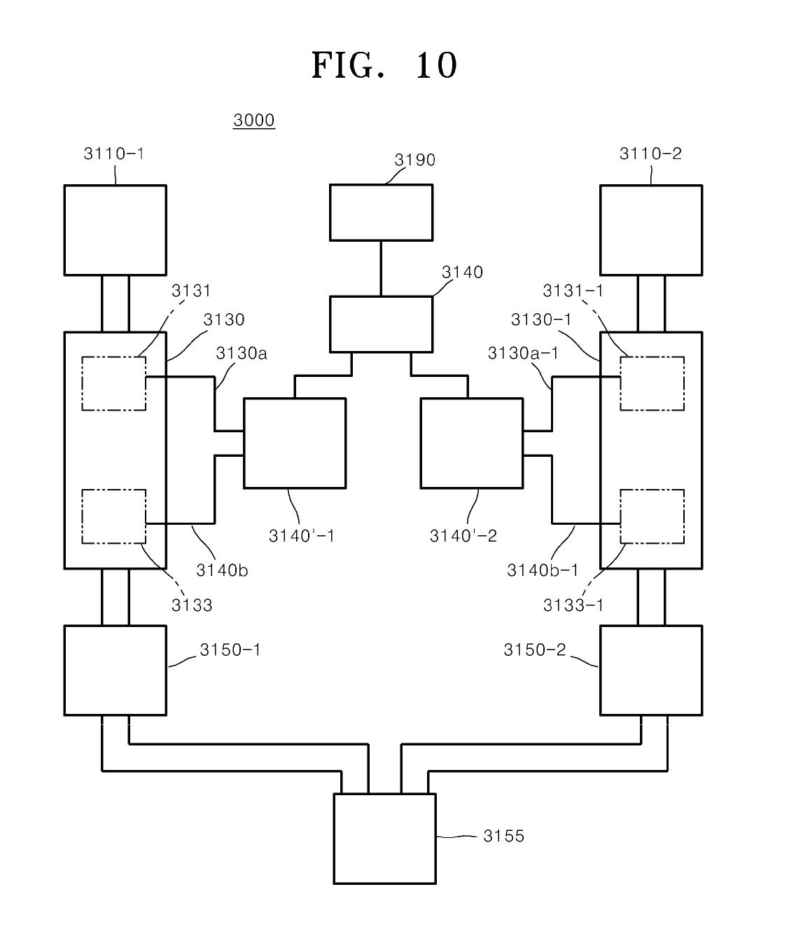

FIGS. 8 and 9 are schematic diagrams of a facility for purifying harmful gas 1000, 2000 according to still yet another exemplary embodiment of the present inventive concept. Referring to FIG. 8, the facility for purifying harmful gas 1000 includes a microwave generator 190 and a microwave splitting unit 140 for splitting the microwave generated by the microwave generator 190.

The facility for purifying harmful gas 1000 includes a plurality of wave guides 140a, 140b transferring the microwave, thus, the microwave splitting unit 140 is required to provide the microwave into the each of the wave guides 140a, 140b from the one microwave generator 190. But the total cost may be reduced due to installing one microwave generator 190.

Especially, the microwave splitting unit 140 is advantageous for the structure generating firing discharge and diffusing discharge in the first region 131 and the second region 133 of the plasma discharge, respectively, because the microwave splitting unit 140 may transfer the microwave with comparatively strong energy to the first region such that firing discharge may be generated in the first region 131 and diffusing discharge may be generated in the second region 133.

For the diffusing discharge, the second region 133 may receive a part of the plasma discharge particles generated in the first region, accordingly, the distance between the first region 131 and the second region 133 is necessarily affected by the mean free path of the plasma discharge particles. The mean free path is various according to kinds of the plasma discharge particles, so the distance between the first region 131 and the second region 133 is preferred to be below the maximum value of mean free path of the various kinds of the plasma discharge particles. However, the diffusing discharge may be performed smoothly when the value of mean free path of the various kinds of the plasma discharge particles is set below the minimum value or average value of the mean free path.

The number of the wave guides may be three or more unlike the present embodiment. Furthermore, the positions of the wave guides may be arranged in a circumferential direction at a certain area along the harmful gas flow direction unlike the present embodiment. A discharge region of the plasma discharge chamber in which the first wave guide is formed performs firing discharge, and a discharge region of the plasma discharge chamber in which the other wave guide is formed performs diffusing discharge, in case that a plurality of the wave guides are arranged in a harmful gas flow direction. But additional wave guides may be further arranged in the discharge region performing the diffusing discharge so as to perform the firing discharge.

The facility for purifying harmful gas 2000 in FIG. 9 may further include a microwave coupling unit. The microwave coupling unit combines microwave energy provided by each microwave generator and generates the microwave of stronger energy, when a plurality of microwave generators are installed. The facility for purifying harmful gas 2000 includes both of the microwave coupling unit and the microwave splitting unit.

The facility for purifying harmful gas 2000 includes a first, a second, a third microwave generators 190a, 190b, 190c, a microwave splitting unit 140, a micro coupling unit 140′, wave guides 140a, 140b, and a plasma discharge chamber 130.

The first, second, third microwave generators 190a, 190b, 190c generate microwave, respectively. The microwave splitting unit 140 splits the microwave generated by the first microwave generator 190a. The microwave coupling unit 140′ combines microwave energy from the second, third microwave generators 190a, 190b, and the microwave splitting unit 140 and generates the microwave that has stronger energy. The plasma discharge chamber 130 includes a first region 131 and a second region 133 generating plasma discharge. The first region 131 is provided with the microwave generated by the microwave coupling unit 140′ through the wave guide 140a and generates plasma discharge. The second region 133 is provided with the microwave generated by the microwave splitting unit 140 through the wave guide 140b and generates plasma discharge.

As such, microwave of desired size by coupling or splitting the microwave provided by the plurality of microwave generators may be generated and provided to the plasma discharge chamber. Especially, the microwave of stronger energy may be provided to the first region 131 easily, when the first region 131 performs firing discharge, and then, the second region 133 performs diffusing discharge. The harmful gas goes through the plasma discharge chamber 130 and is discharged through a vacuum pump 150 and a scrubber 155.

The microwave generated by the first microwave generator 190a is split by the microwave splitting unit 140 to be transferred to the microwave coupling unit 140′ and the second region 133 of the plasma discharge chamber 130, but the embodiments are not restricted thereto, and the microwave splitting unit 140 may be omitted such that the microwave generated by the first microwave generator 190a is transferred to the second region 133 directly.

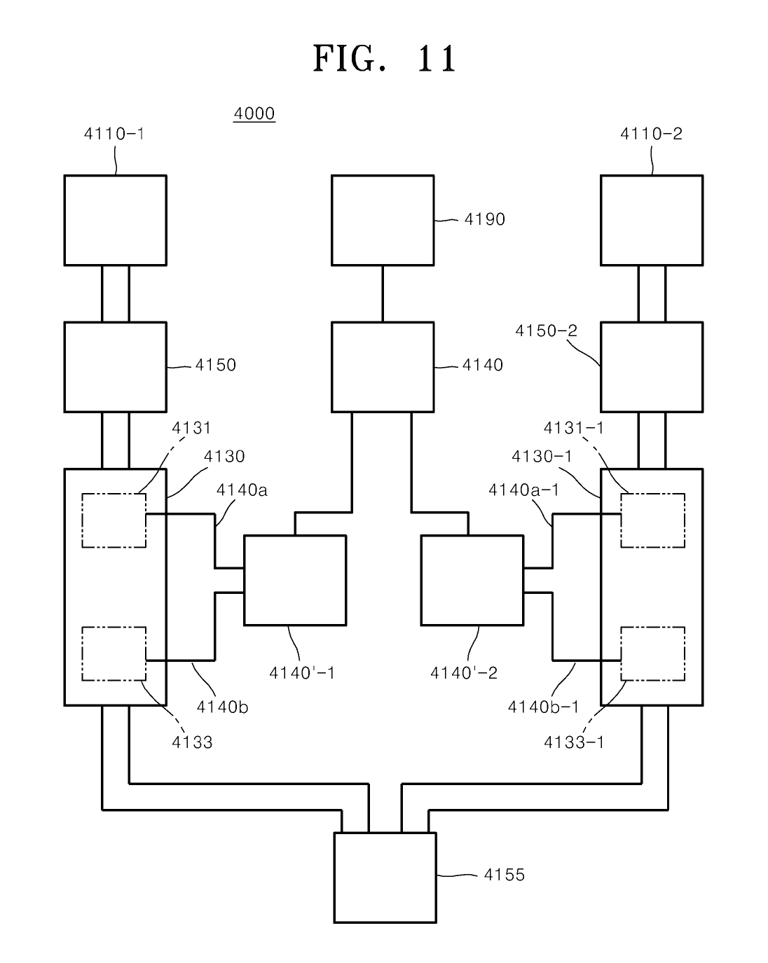

FIG. 10 is a schematic diagram of a facility for purifying harmful gas 3000 according to still yet another exemplary embodiment of the present inventive concept. The facility for purifying harmful gas 3000 includes a microwave generator 3190, a first microwave splitting unit 3140, a second microwave splitting unit 3140′4, 3140′-2, a first plasma discharge chamber 3130, and a second plasma discharge chamber 3130-1. The embodiment includes a first process chamber 3110-1, a second process chamber 3110-2, a first vacuum pump 3150-1, and a second vacuum pump 3150-2. The first vacuum pump 3150-1 is connected to the first process chamber 3110-1 so as to discharge harmful gas of the first process chamber 311-1, and the second vacuum pump 3150-2 is connected to the second process chamber 3110-2 so as to discharge harmful gas of the second process chamber 3110-2.

The microwave generator 3190 generates microwave. The first microwave splitting unit 3140 separates a first microwave from the microwave generated in the microwave generator 3190 and provides the same into the second microwave splitting unit 3140′4, 3140′-2. The first microwave provided to the second microwave splitting unit 3140′-1, 3140′-2 is separated into the second microwave to be provided to a first region 3131 and a second region 3133 of the first plasma discharge chamber 3130 and to a first region 3131-1 and a second region 3133-1 of the second plasma discharge chamber 3130-1 through waveguides 3130a, 3140b connected to the first plasma discharge chamber 3130 and waveguides 3130a-1, 3140b-1 connected to the second plasma discharge chamber 3130-1.

The first plasma discharge chamber 3130 disposes harmful gas input from the first process chamber 3110-1, and the second plasma discharge chamber 3130-1 disposes harmful gas input from the second process chamber 3110-2. The first vacuum pump 3150-1 is installed in the rear of the first plasma discharge chamber 3130, and the second vacuum pump 3150-2 is installed in the rear of the second plasma discharge chamber 3130-1. But one vacuum pump may discharge harmful gas in both of the first process chamber 3130-1 and the second process chamber 3110-2. Also, two vacuum pumps may be installed in one process chamber, each of the plasma discharge chamber may be installed in each front of the two vacuum pumps, and the split microwave separated by the first microwave splitting unit 3140 and the second microwave splitting unit 3140′-1, 3140′-2 may be provided to the plasma discharge chambers.

The remaining noxious substances in the harmful gas went through the first vacuum pump 3150-1 and the second vacuum pump 3150-2 may be further removed in a scrubber 3155.

FIG. 11 is a schematic diagram of a facility for purifying harmful gas 4000 according to still yet another exemplary embodiment of the present inventive concept. The facility for purifying harmful gas 4000 of FIG. 11 has identical structure with the facility for purifying harmful gas 3000 of FIG. 10. Accordingly, descriptions on the same structure with the facility for purifying harmful gas 3000 will be omitted except drawing references and names, and only the differences between the structures will be described.

The facility for purifying harmful gas includes a microwave generator 4190, a first microwave splitting unit 4140, a second microwave splitting unit 4140′-1, 4140′-2, a first plasma discharge chamber 4130, a second plasma discharge chamber 4130-1, a first process chamber 4110-1, a second process chamber 4110-2, a first vacuum pump 4150, a second vacuum pump 4150-2, and a scrubber 4155.

Microwave is provided to a first region 4131 and a second region 4133 of the first plasma discharge chamber 4130 and to a first region 4131-1 and a second region 4133-1 of the second plasma discharge chamber 4130-1 through wave guides 4140a, 4140b, 4140a-1, 4140b-1 each connected to the first plasma discharge chamber 4130 and the second plasma discharge chamber 4130-1.

A first vacuum pump 4150 is installed in the rear of a first process chamber 4110-1, and a plasma discharge chamber 4130 is installed in the rear of the first vacuum pump 4150. A second vacuum pump 4150-2 is installed in the rear of a second process chamber 4110-2, and a second plasma discharge chamber 4130-1 is installed in the rear of the second vacuum pump 4150-2. That is, there is only one difference of changing the position of the vacuum pump and the plasma discharge chamber with the facility for purifying harmful gas 3000 in FIG. 10.

While the present invention has been particularly shown and described with reference to exemplary embodiments thereof, it will be understood that various changes in form and details may be made therein without departing from the spirit and scope of the following claims.

What is claimed is:

1. A facility for purifying harmful gas disposing harmful gas discharged from at least one process chamber in which processes are performed in the vacuum status by a vacuum pump comprising:
one or a plurality of microwave generators generating microwave;
a plurality of wave guides including a wave path through which the microwave generated by the microwave generator is provided;
a plasma discharge chamber including the wave guides connected by a certain distance along the harmful gas flow direction outside, wherein the microwave input through the wave guide is reflected inside the plasma discharge chamber to form a plurality of plasma discharge regions in which plasma discharge is generated; and
a shield installed inside the plasma discharge chamber to be longer than the length between the plurality of plasma discharge regions for covering the plasma discharge regions at the same time, formed with a tube cylinder for flowing the harmful gas input from the process chamber or a part of it, and preventing ions or electrons for the plasma discharge from leaking outside by contacting with the plasma discharge chamber.

2. The facility for purifying harmful gas of claim 1, wherein one of the plasma discharge regions performs firing discharge so as to decompose noxious substances and the other or the plurality of the plasma discharge regions perform diffusing discharge by plasma particles generated in the plasma discharge region in which plasma firing discharge is generated.

3. The facility for purifying harmful gas of claim 2, wherein the electric field intensity of the plasma discharge region performing the diffusing discharge is lower than the plasma discharge region performing the firing discharge.

4. The facility for purifying harmful gas of claim 2, wherein the plasma power to be transferred to the plasma discharge region performing the firing discharge is larger than the plasma power to be transferred to the plasma discharge region performing the diffusing discharge.

5. The facility for purifying harmful gas of claim 1, wherein a reflection chamber is further included with extension from the plasma discharge chamber horizontally to the plasma discharge region and generates firing discharge by concentrating electric field by constructive interference between the microwave reflected inside the plasma discharge chamber and the microwave input through the wave guide while reflecting the microwave input through the wave guide.

6. The facility for purifying harmful gas of claim 5, wherein a cross-section area of the reflection chamber is larger than one of the plasma discharge chamber.

7. The facility for purifying harmful gas of claim 5, wherein the other discharge region except for the region performs diffusing discharge by plasma particles generated in the plasma discharge region.

8. The facility for purifying harmful gas of claim 1 further comprises a microwave splitting unit splitting the microwave generated by the microwave generator and providing the microwave to each wave guide in case of comprising one microwave generator.

9. The facility for purifying harmful gas of claim 5, wherein the average thickness of the reflection chamber is thinner than the one of the wave guide, and the width of the reflection chamber is larger than the one of the wave guide.

10. The facility for purifying harmful gas of claim 5, wherein the width of the reflection chamber is increasing in a longitudinal direction by the predetermined length from the width of the wave guide successively.

11. The facility for purifying harmful gas of claim 5, wherein the thickness of the reflection chamber reduces as the width of the reflection chamber increases.

12. The facility for purifying harmful gas of claim 1 further comprising:
a plurality of the microwave generators; and
a microwave coupling unit coupling microwaves transferred from at least two microwave generators; and
wherein the microwave coupled in the microwave coupling unit is provided to one of the wave guides.

13. The facility for purifying harmful gas of claim 1, wherein at least two of the wave guides are installed at a certain position of the pipe connected to the one or the plurality of the process chambers along the circumferential direction separately.

14. The facility for purifying harmful gas of claim 1, wherein the shield is a quartz conduit or ceramic conduit.

15. The facility for purifying harmful gas of claim 1, wherein the shield is inserted into the plasma discharge chamber with a conduit form so as to be attached to the inner surface of the plasma discharge chamber by the outer circumference surface.

16. The facility for purifying harmful gas of claim 1, wherein the plurality of wave guides are arranged along the circumferential direction at a central axis of the plasma discharge chamber separated with each other at a predetermined angle.

17. The facility for purifying harmful gas of claim 1, wherein a reaction gas provider providing reaction gas such that the harmful gas may flow in a swirl form inside the plasma discharge chamber is further included at the side of inlet of the plasma discharge chamber.

18. The facility for purifying harmful gas of claim 1, wherein a mesh member for blocking the microwave while passing the harmful gas is installed at the inlet and the outlet of the plasma discharge chamber, respectively.

19. A facility for purifying harmful gas disposing harmful gas discharged from at least one process chamber in which processes are performed in the vacuum status by a vacuum pump comprising:
one or a plurality of microwave generators generating microwave;
a first microwave splitting unit separating the microwave generated in the microwave generator;
a second microwave splitting unit separating the first microwave separated in the first microwave splitting unit;
a plurality of wave guides including a wave path through which the second microwave separated in the second microwave splitting unit;
a plasma discharge chamber including the wave guides connected by a certain distance along the harmful gas flow direction outside, wherein the second microwave input through the wave guide is reflected inside the plasma discharge chamber to form a plurality of plasma discharge regions in which plasma discharge is generated by the second microwave while being reflected inside the plasma discharge chamber;
a shield installed inside the plasma discharge chamber to be longer than the length between the plurality of plasma discharge regions for covering the plasma discharge regions at the same time, formed with a tube cylinder with a through hole for flowing the harmful gas input from the process chamber or a part of it, and preventing ions or electrons for the plasma discharge from leaking outside by contacting with the plasma discharge chamber, and
wherein a plurality of vacuum pumps are installed so as to discharge harmful gas inside one of the process chambers; and
wherein the second microwave splitting unit transfers the second microwave to the wave guides connected to the front of the vacuum pumps, respectively, in the plasma discharge chamber.

20. A facility for purifying harmful gas disposing harmful gas discharged from at least one process chamber in which processes are performed in the vacuum status by a vacuum pump comprising:
one or a plurality of microwave generator generating microwave;
a first microwave splitting unit separating the microwave generated in the microwave generator;
a second microwave splitting unit separating the first microwave separated in the first microwave splitting unit;
a plurality of wave guides including a wave path through which the second microwave separated in the second microwave splitting unit;
a plasma discharge chamber including the wave guides connected by a certain distance along the harmful gas flow direction outside, wherein the second microwave input through the wave guide is reflected inside the plasma discharge chamber to form a plurality of plasma discharge regions in which plasma discharge is generated by the second microwave while being reflected inside the plasma discharge chamber;
a shield installed inside the plasma discharge chamber to be longer than the length between the plurality of plasma discharge regions for covering the plasma discharge regions at the same time, formed with a tube cylinder with a through hole for flowing the harmful gas input from the process chamber or a part of it, and preventing ions or electrons for the plasma discharge from leaking outside by contacting with the plasma discharge chamber, and
wherein a plurality of vacuum pumps are installed so as to discharge harmful gas inside one of the process chambers; and
wherein the second microwave splitting unit transfers the second microwave to the wave guides connected to the rear side of the vacuum pumps, respectively, in the plasma discharge chamber.
